(19) United States
(12) Patent Application Publication
(10) Pub. No.: US 2017/0114594 A1
(43) Pub. Date: Apr. 27, 2017

(54) ROCK DRILLING RIG

(71) Applicant: SANDVIK MINING AND CONSTRUCTION OY, Tampere (FI)

(72) Inventors: Pekka ANTTONEN, Tampere (FI); Jussi PUURA, Pihtisulunkatu (FI); Samuli VERHO, Tampere (FI)

(21) Appl. No.: 15/299,790

(22) Filed: Oct. 21, 2016

(30) Foreign Application Priority Data
Oct. 22, 2015 (EP) 15190930.6

(51) Int. Cl. E21B 7/02; F15B 11/17; F15B 13/06; E21B 6/00

(52) U.S. Cl. CPC E21B 7/022; E21B 7/025; E21B 6/00; F15B 11/17; F15B 13/06; F15B 2211/20576; F15B 2211/30525

(57) ABSTRACT

A rock drilling rig includes a drilling unit that is provided with hydraulically operated actuators, such as an impact device, a rotation device and a feed device. The impact device and the rotation device are connected to dedicated hydraulic circuits provided with dedicated supply and discharge lines and are controlled by means of dedicated control valves being on the a carrier of the rock drilling rig. The feed device is connected to a distributed hydraulic system, wherein several actuators are connected to a common hydraulic circuit (CHC) provided with one common supply line and one common discharge line and are controlled by several distributed valves. The distributed valve of the feed device is located at the drilling unit.

### RELATED APPLICATION DATA

This application claims priority under 35 U.S.C. §119 to EP Patent Application No. 15190930.6, filed on Oct. 22, 2016, which the entirety thereof is incorporated herein by reference.

### TECHNICAL FIELD

The present disclosure relates to a rock drilling rig including a carrier and one or more drilling booms provided with drilling units. The drilling unit includes a drilling machine provided with a hydraulic impact or percussion device and a hydraulic rotation device. The rock drilling machine is supported movably on a feed beam and may be moved by a hydraulic feed device. Hydraulic actuators of the rock drilling rig may be connected to one or more hydraulic systems.

### BACKGROUND

In rock drilling, drill holes are drilled in rock material or soil by means of rock drilling machines arranged on rock drilling rigs. The drill holes may be drilled in mines, quarries and construction work sites and the drill holes may be blast holes, reinforcing holes or drill holes having any other purpose. The rock drilling rig is typically hydraulically operated and includes several hydraulic actuators connected to a hydraulic system by means of feed lines and discharge lines.

The rock drilling rig may include several hydraulic boom actuators and several hydraulic drilling actuators. In a conventional control system each of the hydraulic actuators are equipped with separate pressure and return lines, whereby number of hydraulic hoses is large. In order to decrease the number of hydraulic hoses a distributed actuator system is used. However, it has been noted that present solutions relating to the hydraulic systems of the rock drilling rigs are not constructed in a fully satisfactory manner.

### SUMMARY

To overcome the above disadvantages, the present disclosure is directed to a rock drilling rig that includes two or more conventional centralized hydraulic systems and at least one distributed hydraulic system. Thus, a combination of different hydraulic systems is utilized.

Each of the centralized hydraulic systems is dedicated for one hydraulic actuator and includes an actuator specific supply line, an actuator specific discharge line and one or more control valves. The control valve of the centralized hydraulic system is located at a carrier of the rock drilling rig. The distributed hydraulic system includes several hydraulic devices connected to one common supply line and one common discharge line. Further, the distributed hydraulic system is provided with several actuator specific control valves, which are not located at the carrier, but are instead distributed and are thereby closer to the hydraulic actuators.

The rock drilling rig is provided with one or more drilling units having at least one rock drilling machine provided with a hydraulically operated impact or percussion device and a hydraulically operated rotation device. The impact device and the rotation device are connected to dedicated hydraulic circuits. In other words, the impact device and the rotation device both have a dedicated supply line, a dedicated discharge line and one or more dedicated control valves. Thereby, the impact device and the rotation device are connected to the centralized hydraulic systems and are controlled by means of dedicated control valves, which are located at the carrier.

Further, the rock drilling rig includes at least one hydraulic feed device for moving the rock drilling machine. The feed device is connected to the distributed hydraulic system and one or more control valves of the feed device is distributed. Thereby, the control valve of the feed device is not located at the carrier, but is instead located at the drilling unit. In other words, the impact control valve and the rotation control valve are kept on a carrier of a rock drilling rig while feed control valve is arranged to the drilling unit.

An aspect of the disclosed solution is that the feed operation may be controlled more accurately since the control valve of the feed device is distributed and is located closer to the feed device. The feed may react faster to the control commands and changes in challenging drilling circumstances. On the other hand, controlling the impact and rotation operations in a conventional way is found to be effective regarding energy consumption.

A general benefit of the use of the distributed hydraulic system is that less hydraulic ducts or hoses are required, whereby weight of the boom and the drilling unit may be lower and visibility may be better. Additionally, the distributed hydraulic system facilitates a later addition of optional features and actuators to the system without requiring redesign of the entire hydraulic system. Actuators may be retrofitted, removed and changed to the distributed system even at the work site. Thus, the distributed system improves flexibility not only for the operation but also to manufacturing of the rock drilling rig. Further, serviceability and diagnostics of the distributed hydraulic system may be improved compared to the traditional centralized system.

According to an embodiment, the drilling unit of the rock drilling rig includes several hydraulic auxiliary devices. The auxiliary devices of the drilling unit are connected to the distributed hydraulic system, which is common with the feed device. Thanks to the distributed hydraulic system, it is easier to equip the drilling unit and the boom with different hydraulic auxiliary devices. The system also improves possibility to retrofitting of the hydraulic actuators and devices. Compared to the traditional centralized hydraulic system, the distributed hydraulic system, or common rail hydraulic system, requires a significantly lower amount of hoses.

According to an embodiment, the drilling unit of the rock drilling rig includes several auxiliary devices, as disclosed in the previous embodiment. In this embodiment, however, the auxiliary devices of the drilling unit are drilling tool handling devices. The auxiliary devices of the drilling unit may be the following devices: a drilling tool retainer, a drilling tool centralizer, a drilling tool magazine and a drilling tool changer. The distributed hydraulic system allows easy and fast mounting and dismounting of different types of tool handling actuators and devices. Thereby, the drilling unit may be equipped with the devices needed in different drilling situations.

According to an embodiment, the drilling unit of the rock drilling rig includes several hydraulic auxiliary devices. The auxiliary devices of the drilling unit are connected to the distributed hydraulic system, which is common with the feed device. Further, at least one of the auxiliary devices is part of the rock drilling machine and is configured to have effect on axial position of a drilling tool connectable to the rock drilling machine. Thereby, the auxiliary device of rock drilling machine may be a hydraulically operated axial bearing or a hydraulically operated power extractor, for example. The distributed hydraulic system allows use of different type of rock drilling machines and makes their mounting and dismounting easy and fast. Further, the drilling unit may be equipped with a rock drilling machine, which suits best for each drilling situation and conditions.

According to an embodiment, the boom includes at least two boom parts, joints between the boom parts and several hydraulic boom actuators for moving the boom and the boom parts relative to each other and relative to a carrier. The boom actuators are connected to the distributed hydraulic system, which is shared at least with the feed device. The boom actuators are controlled by means of distributed valves, which are located at the boom. The boom actuators are connected to a common rail hydraulic circuit and may be actuators for moving the boom parts, at least one lifting actuator and at least one swing actuator, which are located at a portion of the first end of the boom.

Control valves of the lifting actuator and the swing actuator are connected to the distributed hydraulic system and are located at a boom area. In addition, a boom extension or zoom actuator may also be connected to the distributed hydraulic system as well as a roll-over actuator, which is located between the free end of the boom and the drilling unit. The boom includes several hydraulic actuators, whereby the use of the distributed hydraulic system simplifies supply of hydraulic power to the boom area compared to the centralized system. Further, controlling of the boom actuators may be more accurate and reaction to the control commands may be faster because boom valves are located close to the boom actuators.

According to an embodiment, the rock drilling rig includes one or more hydraulic pressure sources, such as hydraulic pumps, which are located on the carrier together with an impact valve and a rotation valve. One possibility is that on the carrier is one single hydraulic pump arranged to produce hydraulic power for all of the hydraulic devices of the drilling unit and the drilling boom. The hydraulic pump may be of an adjustable type of pump.

According to an embodiment, the rock drilling rig includes two pressure sources—a first hydraulic pump and a second hydraulic pump. The first hydraulic pump is configured to provide hydraulic power for the impact device and the second hydraulic pump is configured to provide hydraulic power for the rotation device. In addition, the first hydraulic pump provides needed hydraulic power for the distributed hydraulic system. Production of hydraulic power for the impact and rotation functions is thereby separated, and no additional pressure sources are needed for the distributed hydraulic system. In other words, the hydraulic system may have a double pump system or unit for supplying all the needed drilling power. The first hydraulic pump, i.e. the impact pump, may be dimensioned to be greater than the second hydraulic pump, i.e. the rotation pump since producing impacts is typically the most energy demanding function in the rock drilling. The rotation pump may be adjustable in order to effect on produced pressure and flow in the hydraulic rotation circuit. Displacement capacity of the rotation pump may be adjustable, for example. The rotation valve may be a simple directional control valve for controlling direction of rotation of the rotation device.

According to an embodiment, the rock drilling rig includes a control system of the distributed hydraulic system, which is provided with at least one data bus being in communication at least with the valve drivers of the distributed valves of the distributed hydraulic system. Due to the data bus, the number of electrical cables needed may be minor compared to the use of actuator specific cabling.

According to an embodiment, the distributed hydraulic system includes valve drivers for controlling the distributed valves. The valve drivers may be connected to a data bus for receiving bus data send from one or more control units. The data bus or fieldbus of the control system may be a CAN-bus (Controlled-Area-Network-bus). Different communication protocols and standards of the CAN-bus based data bus or field bus, such as CANOpen, may be utilized. Alternatively, the data bus may be an Ethernet-based bus, for example. The valve driver may transfer the bus data into control data for controlling a dedicated valve actuator arranged to move control element of the distributed valve.

The control valve may have an electrical turning or moving device arranged to move a control element, such as a control slide, of the control valve. The valve driver may be located in connection with the distributed valve, or alternatively, the valve driver may be located at distance from the distributed valve. One possibility is to arrange several valve drivers to form one larger entity such as a valve driver block, which may be located at a boom of the rock drilling rig, for example. The valve driver and the control valve may be combined to form one unity, or alternatively, the valve driver may be located at a distance from the control valve.

According to an embodiment, the distributed hydraulic system includes a valve block, wherein several distributed valves of the hydraulic devices form one single physical device. The valve block may be located at the drilling unit. This way, the valves are located close to the hydraulic actuators of the drilling unit. Due to the valve block, serviceability of the hydraulic system may be improved. Further, the valve block has a compact structure and saves space, whereby layout of the drilling unit may be designed more freely.

According to an embodiment, the distributed hydraulic system of the rock drilling rig includes one or more valve blocks, wherein several distributed valves of the hydraulic devices form one single physical device. Further, the valve block may have a modular configuration. Thus, the valve block includes a pressure setting valve module, which is common for several hydraulic devices connected to the distributed hydraulic system. The pressure setting valve module is controlled in accordance with the hydraulic power requirement of a currently driven hydraulic device.

The valve block further includes one or more dedicated valve modules including directional valves for controlling movements generated by the hydraulic devices connected to the distributed hydraulic system. The valve block may be configured to control auxiliary devices, such as drilling tool handling devices, which are located at the drilling unit, or auxiliary devices of the rock drilling machine. The valve block has a compact and durable structure. The valve block takes up only a little space, thus it is easy to mount it to a suitable place at the drilling unit.

According to an embodiment, the rock drilling rig includes at least one control system provided with one or more control units for controlling the operation of the hydraulic actuators of the rock drilling rig. The control unit may include one or more processor in order to calculate and process input sensing data and control data, such as control commands. The control unit may also execute one or more software products in the processor for controlling the operation of the actuators of the rock drilling rig. Alternatively, or in addition to, the control unit may have conventional manual control means for producing control commands for the actuators and indicating means for presenting the operational status and effects of the controlled actuator.

The control unit may communicate with sensing devices arranged to monitor operational effects of the hydraulic actuators, and may also communicate with the actuator drivers of the distributed hydraulic system by means of one or more data busses. The control valves of the centralized hydraulic valve may also be controlled under control of the control unit, as well as the one or more hydraulic pumps of the hydraulic system.

The above disclosed embodiments and features can be combined in order to form suitable solutions provided with necessary features.

The foregoing summary, as well as the following detailed description of the embodiments, will be better understood when read in conjunction with the appended drawings. It should be understood that the embodiments depicted are not limited to the precise arrangements and instrumentalities shown.

### BRIEF DESCRIPTION OF THE DRAWINGS

FIG. 1 is a schematic side view showing a rock drilling rig for underground work sites and arranged to implement the disclosed hydraulic systems.

FIG. 2 is a schematic diagram showing some basic features of a rock drilling, which is in accordance with the present disclosure.

FIG. 3 is a schematic view of a part of a distributed hydraulic system implemented in the disclosed rock drilling rig.

FIG. 4 is a schematic diagram showing a centralized hydraulic system implemented in the disclosed rock drilling rig and utilizing single pump for producing needed hydraulic power.

FIG. 5 is a schematic diagram showing a centralized hydraulic system implemented in the disclosed rock drilling rig and utilizing a double pump unit for producing needed hydraulic power.

FIG. 6 is a schematic view showing a principle of a valve block connectable to the distributed hydraulic system in order to control one or more auxiliary devices of the drilling unit.

For the sake of clarity, the figures show some embodiments of the disclosed solution in a simplified manner. In the figures, like reference numerals identify like elements.

### DETAILED DESCRIPTION

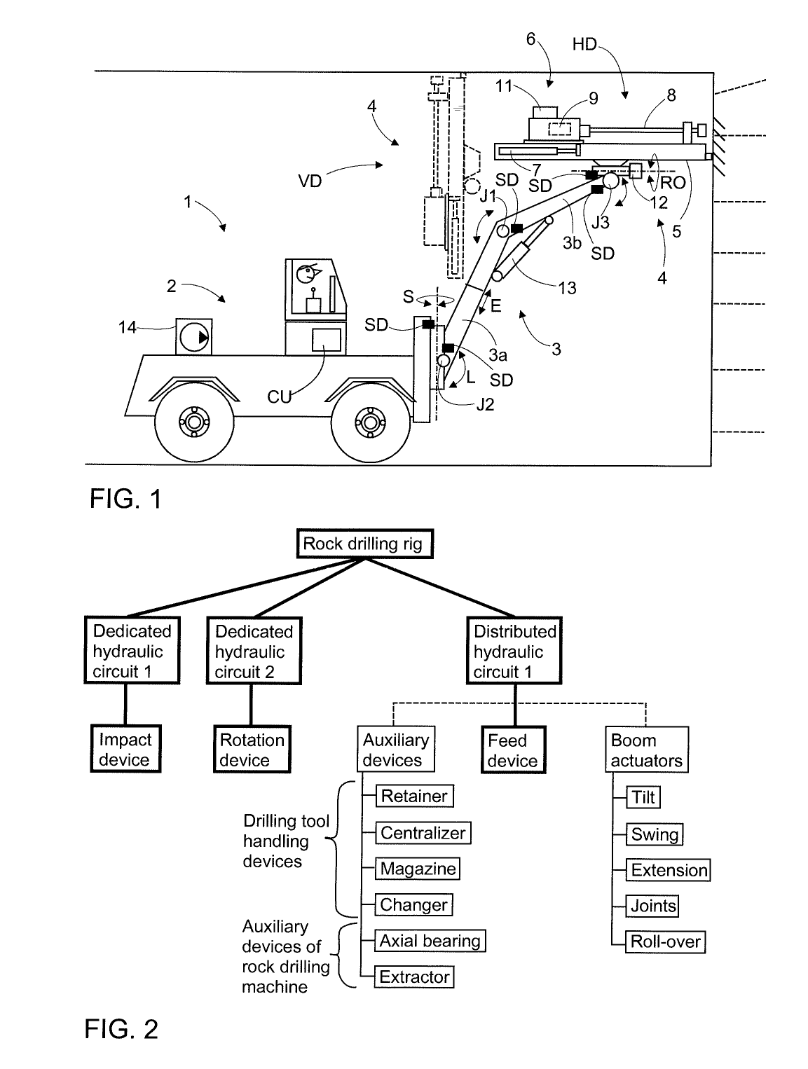

FIG. 1 shows a rock drilling rig 1 intended for horizontal underground drilling HD and for drilling horizontal blast holes when developing new rock spaces. Alternatively, or in addition to, the rock drilling rig may be used for vertical underground drilling VD, such as drilling production blast holes or holes for reinforcing elements, such as rock bolts. It should be appreciated that the solutions and features disclosed herein may also be implemented in other type of rock drilling rigs, such as surface drilling rigs intended for vertical or substantially vertical drilling in quarries and construction work sites.

The rock drilling rig 1 includes a movable carrier 2, one or more drilling booms 3 and drilling units 4 arranged on the booms 3. The drilling unit 4 includes a feed beam 5 on which a rock drilling machine 6 may be moved by means of a feed device 7. Further, the drilling unit 4 includes a drilling tool 8 with which impact pulses given by an impact device 9 of the rock drilling machine 6 are transmitted to the rock to be drilled.

The rock drilling machine 6 further includes a rotation device 11 for turning the drilling tool 8 around its longitudinal axis during the drilling. In addition to, the rock drilling machine 6 may include an axial bearing and a power extractor, both being arranged to influence an axial position of the drilling tool 8. By means of an axial bearing, the relative position between the drilling tool and an impact element, such as a percussion piston, may be influenced.

The power extractor facilitates extraction of the drilling tool from the drill hole being drilled. Feed device 7, impact device 9, rotation device 11, axial bearing and the power extractor may all be hydraulic actuators of the drilling unit 4, whereby they are connected to hydraulic systems in a manner disclosed herein. In addition, the drilling unit may include hydraulic auxiliary devices for handling drilling tools. The drilling tool handling devices may have a retainer for gripping the drilling tool, a centralizer for supporting the drilling tool to drilling axis, a magazine for storing drilling tools and a changer for moving the drilling tool from the magazine to the drilling axis and vice versa.

The drilling boom 3 may include two or more boom parts 3a, 3b connected to each other by means of a joint J1. A first end of the boom 3 may be connected to the carrier 2 by means of horizontal joint J2 allowing lifting L of the boom 3 by means of lifting device, such as a lifting cylinder. The first end of the boom 3 may also include a vertical joint allowing the boom to be moved side wards i.e. to execute a swing (S) movement by means of a swing device, such as a swing cylinder.

At least the first boom part 3a may be extendable (E) by means of a zoom cylinder, for example. At the second end of the boom 3 there may be provided a third joint J3 allowing tilting movement of the rock drilling unit 4, and a roll over joint RO allowing turning of the drilling unit 4 around an axis of the roll over joint by means of roll over device 12. For the shake of clarity, only one boom actuator 13 in addition to the roll over device 12, in this case a cylinder, is shown in FIG. 1. The devices and boom actuators intended for moving the boom 3 and boom parts 3a, 3b are hydraulic actuators, which are connected to the distributed hydraulic system of the rock drilling rig in the manner disclosed herein.

The actuators of the boom 3, the feed device 7 and the auxiliary devices are distributed such that one common hydraulic power circuit may be shared with these several hydraulic actuators. In other words, the hydraulic actuators, excluding the impact device 9 and the rotation device 11, may be connected to a hydraulic common rail system. The distributed actuators are controlled by means of distributed valves, and the control valves may be controlled by means of valve drivers. The valve drivers are controlled on the basis of control data transmitted from a control unit CU via a data bus, for example. On the carrier 2 may be one or more hydraulic pumps 14 serving as a power source for the hydraulic circuits.

The boom 3 may be provided with one or more sensing devices SD for detecting the movements caused by the boom actuators. Also, the actuators of the rock drilling unit 4 and their operational effects may be monitored by means of sensing devices. Sensing data may be transmitted from the sensing devices to one or more control units CU by a data bus, for example.

The control unit or device CU is arranged to control actuators of the rock drilling rig 1. The on-board control device CU may be a computer, processing device or a corresponding device, and it may have a user interface with a display device, as well as control means for giving commands and information to the control unit. The control device CU may be equipped with appropriate software. Alternatively, the control unit CU may have manual control means and may be configured to generate control signals to be transmitted to valve drivers. The term control unit may thereby be interpreted broadly.

FIG. 2 shows some basic features of the disclosed rock drilling rig. As can be noted, the rock drilling rig includes two dedicated hydraulic circuits, one for an impact device and one for a rotation device. The dedicated hydraulic circuits may be the conventional centralized type, wherein control valves are located at a carrier of the rock drilling rig. The system also includes a distributed hydraulic circuit, or a hydraulic common rail circuit, for supplying hydraulic power for a feed device, and possibly for several hydraulic boom actuators and auxiliary devices as previously disclosed.

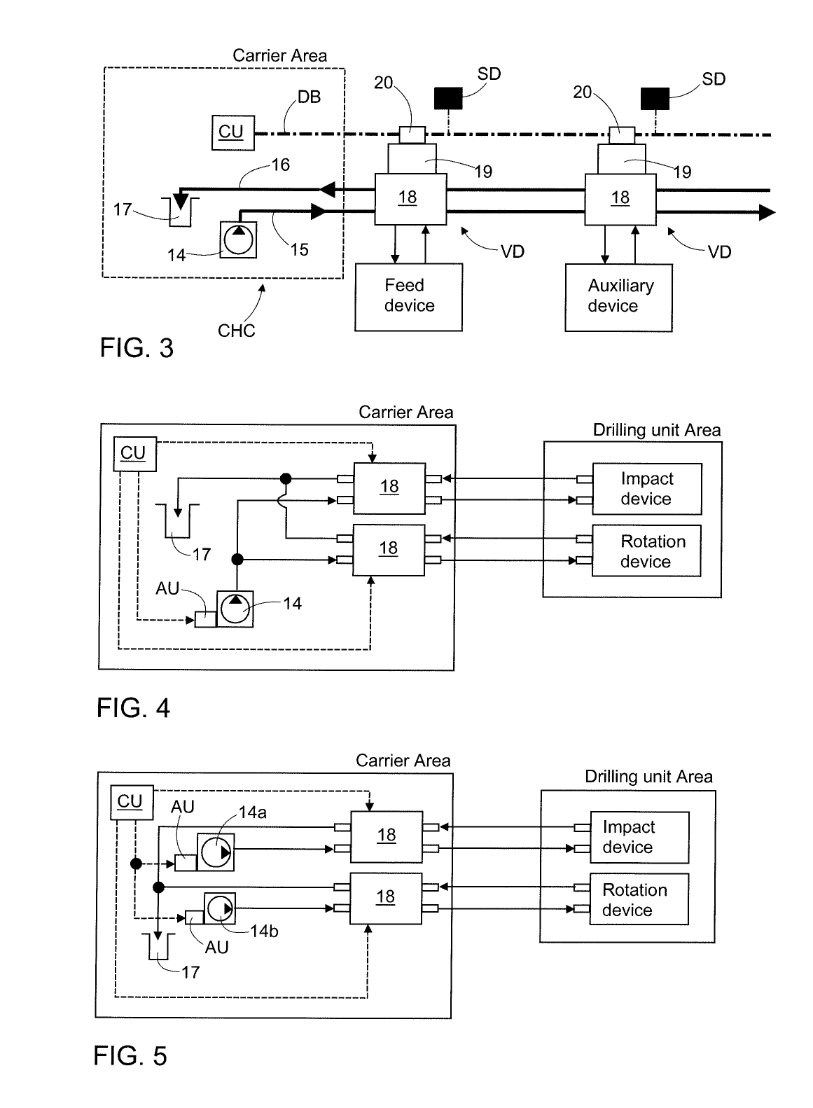

FIG. 3 illustrates a control system of a distributed hydraulic circuit. The system includes several hydraulic actuators, such as a feed device and an auxiliary device, which are connected to a common hydraulic circuit CHC. The system may also include several hydraulic boom actuators. For the sake of clarity, only two hydraulic actuators are shown.

The common hydraulic circuit CHC includes a feed duct or supply line 15 for conveying pressurized hydraulic fluid from a hydraulic pump 14 or source to the hydraulic actuators, and a discharge duct or return line 16 for conveying hydraulic fluid from the hydraulic actuators to a tank 17. The actuators are controlled by means of control valves 18, which open and close connections from the fluid lines 15, 16 of the common hydraulic circuit CHC to ports of the actuators.

The control valves 18 may be controlled by valve drivers VD connected to a data bus DB. The valve driver VD may have a valve actuator 19 for moving a control slide or corresponding control element of the control valve 18. The valve actuator 19 is controlled on the basis of control signals received by a receiver or control device 20 of the valve driver VD. The control device 20 may receive digital data bus signals sent by a control unit CU of the control system, and may transform the digital control data into analog control data for executing control of valve actuator 19. Operational effects of the actuators may be sensed or monitored by means of sensing devices SD, which may be suitable sensors or measuring devices.

In the disclosed embodiment the data transmission is executed by means of one single data bus DB. Thereby, the sensing devices SD and the valve drivers VD are connected to the same data bus DB. However, if need be, the control signals may be transmitted to the receiver 20 through any other suitable data transmission path other than the disclosed data bus DB. As can be seen in FIG. 3, the distributed control valves 18 are located outside a carrier area.

FIGS. 4 and 5 disclose basic principles of control systems of centralized hydraulic circuits. As can be noted, control valves 18 of an impact device and a rotation device are arranged on a carrier area together with one or more hydraulic pumps 14, 14a, 14b. The pumps 14, 14a, 14b may include adjusting units AU or means for adjusting the pressure and/or flow under control of a control unit CU. The control unit CU may also control the control valves 18, or alternatively the control valves may be controlled directly by manual control elements, for example. The features relating to the centralized hydraulic systems are discussed herein.

In FIG. 5, a first pump 14a is dimensioned to have greater capacity to produce hydraulic power than a second pump 14b. That is because the impact device is typically the greatest power consumer of the drilling unit. Thus, the system may have a double pump system having two separate pumps with different hydraulic output capacity.

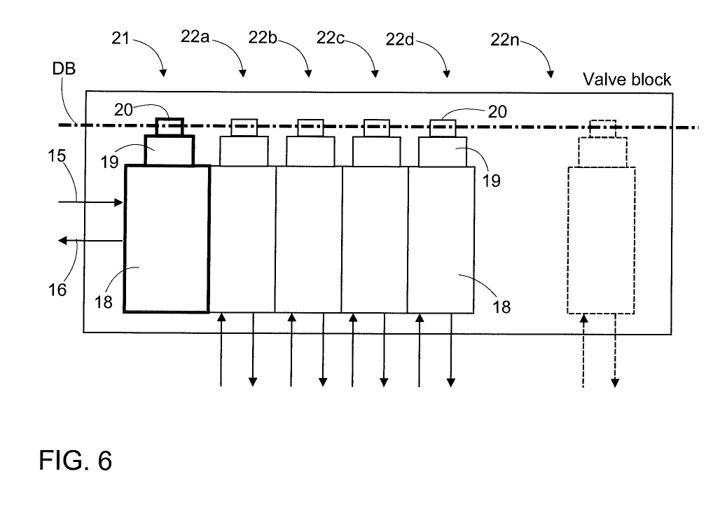

FIG. 6 discloses a principle of a valve block, which may be connected to a distributed hydraulic system. The valve block can include several distributed control valves arranged to form one single physical device. Further, the valve block may have a modular configuration. The valve block may also include a pressure setting valve module 21, which is common for several hydraulic devices connected to the distributed hydraulic system. The pressure setting valve module 21 may be controlled in accordance with the requirement of hydraulic power of a currently driven hydraulic device. The valve block further includes one or more dedicated valve modules 22a-22n. A desired number of the dedicated valve modules 22 may be connected to the valve block and may be removed if necessary.

The valve block may include only the pressure setting valve module 21 and one valve module 22. The dedicated valve modules 22 may have directional valves for controlling movements generated by the hydraulic devices connected to the distributed hydraulic system. The modules 21, 22 of the valve block may be controlled according to the same control principles as the solution disclosed in FIG. 3. The valve block may be configured to control auxiliary devices, such as drilling tool handling devices, which are located at the drilling unit, or auxiliary devices of the rock drilling machine. The valve block is distributed and may be located at the drilling unit, whereby the control valves of the block are located close to the auxiliary devices of the drilling unit.

It should be appreciated that the solution and features disclosed herein may also be applied for other type of rock drilling rigs as disclosed in FIG. 1. Thus, the rock drilling rig may alternatively be a surface drilling machine for drilling vertical drill holes to rock or soil, for example.

Although the present embodiment(s) has been described in relation to particular aspects thereof, many other variations and modifications and other uses will become apparent to those skilled in the art. It is preferred therefore, that the present embodiment(s) be limited not by the specific disclosure herein, but only by the appended claims.

1. A rock drilling rig comprising:
a movable carrier;
at least one boom connected to the carrier;
a drilling unit located at a free end portion of the boom, the drilling unit includes a feed beam, a rock drilling machine supported by the feed beam and a feed device for moving the drilling machine relative to the feed beam, the rock drilling machine including a hydraulically operated impact device and a hydraulically operated rotation device, which are connected to dedicated hydraulic circuits provided with dedicated supply lines and dedicated discharge lines, and which are controlled by dedicated control valves located at the carrier; and
at least one distributed hydraulic system including a plurality of hydraulic devices connected to a common hydraulic circuit provided with one common supply line and one common discharge line, and several distributed valves connected to the supply line and the discharge line for operating the hydraulic devices, and wherein the feed device is hydraulically operated and connected to the distributed hydraulic system and a distributed valve of the feed device located at the drilling unit.

2. The rock drilling rig according to claim 1, wherein the drilling unit includes several hydraulic auxiliary devices, the auxiliary devices of the drilling unit are being connected to the distributed hydraulic system, which is common with the feed device.

3. The rock drilling rig according to claim 2, wherein the auxiliary devices of the drilling unit are drilling tool handling devices.

4. The rock drilling rig according to claim 3, wherein the auxiliary devices of the drilling unit include at least two of the following: a drilling tool retainer, a drilling tool centralizer, a drilling tool magazine, a drilling tool changer.

5. The rock drilling rig according to claim 2, wherein at least one of the auxiliary devices is part of the rock drilling machine, operation of the at least one auxiliary device of the rock drilling machine being configured to effect an axial position of a drilling tool connectable to the rock drilling machine.

6. The rock drilling rig according to claim 1, wherein the boom includes at least two boom parts, a joint between the boom parts and several hydraulic boom actuators for moving the boom and boom parts the boom actuators being connected to the distributed hydraulic system, which is shared at least with the feed device and, distributed valves of the boom actuators being located at the boom.

7. The rock drilling rig according to claim 1, further comprising two pressure sources, a first hydraulic pump and a second hydraulic pump, the first hydraulic pump being configured to provide hydraulic power for the impact device and the distributed hydraulic system and the second hydraulic pump being configured to provide hydraulic power for the rotation device.

8. The rock drilling rig according to claim 1, further comprising a control system of the distributed hydraulic system which is provided with at least one data bus being in communication at least with valve drivers of the distributed valves of the distributed hydraulic system.

9. The rock drilling rig according to claim 1, wherein the distributed hydraulic system includes a valve block, wherein several distributed valves of the hydraulic devices form one single physical device, the valve block being located at the drilling unit.

10. The rock drilling rig according to claim 1, wherein the distributed hydraulic system includes at least one valve block, wherein several distributed valves of the hydraulic devices form one single physical device, the valve block having a modular configuration.

11. The rock drilling rig according to claim 5, wherein the at least one auxiliary device of rock drilling machine is at least one of the following: a hydraulically operated axial bearing, a hydraulically operated power extractor.

12. The rock drilling rig according to claim 10, wherein the valve block includes a pressure setting valve module common for several hydraulic devices connected to the distributed hydraulic system, the pressure setting valve module being controlled according to a requirement of hydraulic power of a currently driven hydraulic device.

13. The rock drilling rig according to claim 12, wherein the valve block includes at least one dedicated valve module including a directional valve for controlling movement generated by at least one hydraulic device connected to the distributed hydraulic system.
